(19) United States
(12) Patent Application Publication
(10) Pub. No.: US 2009/0223542 A1
(43) Pub. Date: Sep. 10, 2009

(54) CLEANING APPARATUS USING ULTRASONIC WAVES

(75) Inventors: Yang-lae Lee, Daejeon (KR); Eui-su Lim, Daejeon (KR); Hyun-se Kim, Seoul (KR)

Correspondence Address: Muncy, Geissler, Olds & Lowe, PLLC, P.O. BOX 1364, FAIRFAX, VA, 22038-1364, US

(73) Assignee: Korea Institute of Machinery & Materials, Daejeon (KR)

(21) Appl. No.: 12/441,099

(22) PCT Filed: Aug. 17, 2007
(86) PCT No.: PCT/KR2007/003939

§ 371 Date: Mar. 12, 2009

(30) Foreign Application Priority Data
Oct. 20, 2006 (KR) 10-2006-0102511

(51) Int. Cl. B08B 3/12

(52) U.S. Cl. 134/187

(57) ABSTRACT

Disclosed herein is a cleaning apparatus using ultrasonic waves. The cleaning apparatus to separate contaminations from a wafer includes a housing receiving an oscillator therein, and a rod coupled to a surface of the oscillator to transmit ultrasonic waves produced from the oscillator to a cleaning solution applied onto an upper surface of the wafer. The oscillator includes a piezo-electric device bonded to a diffusive layer consisting of a near-field region and a far-field region. The rod has a diameter-reduced portion to amplify the ultrasonic waves produced from the oscillator, thereby enabling the efficient removal of the contaminations on the wafer to be cleaned.

### BACKGROUND OF THE INVENTION

1. Field of the Invention

The present invention relates to a cleaning apparatus using ultrasonic waves, and, more particularly, to a cleaning apparatus using ultrasonic waves to separate contaminations from a wafer, which comprises: a housing receiving an oscillator therein; and a rod coupled to a surface of the oscillator to transmit ultrasonic waves produced from the oscillator to a cleaning solution applied onto an upper surface of the wafer, the oscillator including a piezoelectric device bonded to a diffusive layer consisting of a near-field region and a far-field region, and the rod having a diameter-reduced portion to amplify the ultrasonic waves produced from the oscillator for the efficient removal of the contaminations on the wafer to be cleaned.

2. Description of the Related Art

One of the most basic technologies among semiconductor manufacturing processes is a cleaning technology. A semiconductor is manufactured via several processes to form a desired wafer surface. As each process is performed on a semiconductor wafer by means of semiconductor manufacturing equipment, various contaminations are created and left on the semiconductor wafer and the semiconductor manufacturing equipment. Therefore, it is necessary to clean the semiconductor wafer and the semiconductor manufacturing equipment by a predetermined time interval while performing processes. A cleaning technology is to remove various contaminations caused during the manufacture of a semiconductor by physical and chemical methods.

First, a chemical method is to remove contaminations on a wafer surface by washing, etching, oxidation/de-oxidation, etc., and uses various chemicals or gases. In the chemical method, particles attached to a wafer surface are removed by use of a pure or chemical cleaning solution, and organic substances are removed in various manners, for example, they may be dissolved by use of a solvent, they may be removed by use of an oxidizing acid, or they may be carbonized under an atmosphere of oxygen plasma. As occasion demands, the chemical method is performed to etch a wafer surface by a predetermined depth so as to expose a new, clean surface.

Next, in a physical method, contaminations attached onto a wafer surface may be peeled off by use of ultrasonic-wave energy, may be brushed off, or may be removed by use of high-pressure water. Generally, when the physical and chemical methods are appropriately combined, a highly efficient cleaning can be accomplished.

A representative example of appropriately combining the physical and chemical methods is an ultrasonic cleaning. The ultrasonic cleaning removes contaminations attached to an object to be cleaned by use of physical means (ultrasonic waves) and chemical means (chemical cleaning solution) and prevents re-attachment of the contaminations. Here, a physical way using ultrasonic waves is based on the cavitation (cavity) phenomenon of ultrasonic waves. The cavitation phenomenon is that fine air bubbles are produced and disappear by a pressure of ultrasonic waves as an ultrasonic-wave energy is propagated in a solution. The cavitation phenomenon accompanies a very high pressure (several tens to hundreds atmosphere) and a high temperature (several hundreds to thousands degrees centigrade).

In the above described phenomenon, with a shock energy caused as air bubbles are repeatedly produced and disappear within an extremely short time (one tens thousandth to one hundreds thousandth second), invisible inner deep portions of an object to be cleaned, which is immersed in a cleaning solution, can be cleaned within a short time.

Actually, in addition to the shock energy caused by the cavitation, an agitation effect, thermal action, etc. by ultrasonic radiation pressure have a synergy effect with a detergent, resulting in a high cleaning efficiency.

The ultrasonic cleaning is mainly used to clean or rinse an object to be cleaned, such as a glass substrate for a liquid crystal display (LCD) apparatus, a semiconductor wafer, and a magnetic disk for the storage of data. In a conventional ultrasonic cleaning system, an object to be cleaned is introduced into a cleaning vessel, and the cleaning vessel receives a cleaning solution to which ultrasonic waves are transmitted from an oscillating plate as the oscillating plate is activated by an ultrasonic oscillator. Ultrasonic waves apply an oscillation energy to particles on the object to be cleaned, thereby efficiently removing the particles and other contaminations from the object.

Recently, with the use of a high-integration semiconductor device, it has been required to form a very fine pattern on a wafer. However, since the pattern on the wafer easily causes a defective semiconductor device even by the attack of super fine particles, the importance of a cleaning process is increasing more and more.

Generally, a wafer cleaning is performed by use of ultra-pure water (cleaning solution), brush, and ultrasonic waves.

FIG. 1 illustrates the configuration of a conventional ultrasonic cleaning apparatus, which is designed to clean a surface of a semiconductor wafer 105 by use of ultrasonic waves and cleaning water (or cleaning solution). The conventional ultrasonic cleaning apparatus comprises a cleaning solution injector 106 having a nozzle-shaped lower end, and a supply tube 102 connected to the sidewall of the injector 106 to supply a cleaning solution 103 into the injector 106.

If the cleaning solution 103 is supplied into the injector 106 through the supply tube 102, an oscillator 101 sends ultrasonic waves to the cleaning solution 103, thereby injecting the cleaning solution 103 with the ultrasonic waves onto an object to be cleaned that is located below the cleaning solution injector 106. During the injection of the cleaning solution, the object to be cleaned is rotated by a rotating shaft 104 such that the overall surface of the object can be cleaned.

In the above described conventional cleaning apparatus, however, since the cleaning solution 103 is injected from the cleaning solution injector 106 after being previously combined with the ultrasonic waves within the cleaning solution injector 106, there is a problem in that an excessively large amount of cleaning solution 103 is consumed as compared to the resulting cleaning effect.

Further, the ultrasonic waves have a great change in strength even if cleaning conditions, such as an operating frequency, cleaning solution condition, electricity consumption, and cooling conditions, are temporarily changed during a cleaning operation. Furthermore, since the high-pressure cleaning solution is injected through the nozzle-shaped lower end of the injector 106, it may cause a serious damage to a local or overall region of a semiconductor wafer surface.

FIG. 2 illustrates the configuration of another conventional ultrasonic cleaning apparatus. The conventional ultrasonic cleaning apparatus shown in FIG. 2 comprises an elongated horizontal oscillating rod 110 to be disposed above a semiconductor wafer 114 with a predetermined gap, an oscillator 111 coupled to one end of the oscillating rod 110 to provide the oscillating rod 110 with an ultrasonic oscillating energy, and a cleaning water discharger 113 to discharge cleaning water 116 into the gap between the oscillating rod 110 and the semiconductor wafer 114.

To rotate the semiconductor wafer 114, the conventional ultrasonic cleaning apparatus further comprises a rotating plate 112 on which the semiconductor wafer 114 is disposed, and a rotating shaft 115 coupled to the rotating plate 112. In operation, the oscillating rod 110, which is disposed above the semiconductor wafer 114, emits longitudinal ultrasonic waves while the semiconductor wafer 114 is rotated by the rotating shaft 115 and the rotating plate 112, and simultaneously, the cleaning water 116 is sprayed over the semiconductor wafer 114, to allow the overall surface of the semiconductor wafer 114 to be cleaned in an ultrasonic cleaning manner.

In the above described conventional ultrasonic cleaning apparatus shown in FIG. 2, however, since the oscillating rod 110 has a cantilever structure, the cleaning operation is performed only below an axial direction of the oscillating rod 110. This causes a difference in the strength of ultrasonic waves along the oscillating rod 110, making it impossible to achieve a uniform cleaning of, in particular, a finely patterned wafer.

### SUMMARY OF THE INVENTION

Therefore, the present invention has been made in view of the above problems, and it is an object of the present invention to provide a cleaning apparatus using ultrasonic waves, which comprises: a housing receiving therein an oscillator, which produces ultrasonic waves as a piezoelectric device is contracted and expanded upon receiving power during a cleaning of contaminations on a wafer; and a rod coupled to a surface of the oscillator to transmit the ultrasonic waves to cleaning water applied onto an upper surface of the wafer, the piezoelectric device being bonded to a surface of a diffusive layer consisting of a near-field region in which the ultrasonic waves propagate straight and a far-field region in which the ultrasonic waves are diffused and overlapped, to complete the oscillator, and the rod having a diameter-reduced portion to amplify the ultrasonic waves produced from the oscillator for the efficient removal of the contaminations on the wafer.

Additional objects and/or advantages of the invention will be set forth in part in the description which follows and, in part, will be obvious from the description of preferred embodiments of the invention. Also, the objects and/or advantages of the invention will be realized by means and combinations of the following claims.

In accordance with an aspect of the present invention, the above and other objects can be accomplished by the provision of a cleaning apparatus using ultrasonic waves comprising: a tube; a housing coupled to an end of the tube and disposed perpendicular to a wafer to be cleaned while maintaining a gap with the wafer; and an oscillator provided in the housing at a position to face the wafer and used to produce ultrasonic waves.

In accordance with another aspect of the present invention, the above and other objects can be accomplished by the provision of a cleaning apparatus using ultrasonic waves comprising: a hollow housing: an oscillator coupled to the housing at a position to face a wafer to be cleaned and used to produce ultrasonic waves; and a constant-diameter rod having an end coupled to a surface of the oscillator, the rod being disposed perpendicular to an upper surface of the wafer to transmit the ultrasonic waves, produced from the oscillator, to cleaning water applied onto the upper surface of the wafer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the configuration of a conventional ultrasonic cleaning apparatus;

FIG. 2 is a view illustrating the configuration of another conventional ultrasonic cleaning apparatus;.

FIG. 3 is a sectional view illustrating the pole structure of a piezoelectric device according to the present invention;

FIG. 4 is a plan view of FIG. 3;

FIG. 5 is a sectional view illustrating the configuration and basic principle of an oscillator according to the present invention;

FIG. 6 is an explanatory view illustrating the basic principle of the oscillator according to the present invention;

FIG. 7 is a plan view of FIG. 5;

FIG. 8 is a perspective view illustrating an embodiment of the oscillator according to the present invention;

FIG. 9 is a perspective view illustrating an embodiment of the piezoelectric device according to the present invention;

FIG. 10 is a perspective view illustrating a cleaning apparatus according to a first embodiment of the present invention;

FIG. 11 is a perspective view illustrating a cleaning apparatus according to a second embodiment of the present invention;

FIG. 12 is a perspective view illustrating an alternative embodiment of FIG. 11;

FIG. 13 is a perspective view illustrating a cleaning apparatus according to a third embodiment of the present invention;

FIG. 14 is a perspective view illustrating an alternative embodiment of FIG. 13; and

FIG. 15 is a perspective view illustrating a cleaning apparatus according to a fourth embodiment of the present invention.

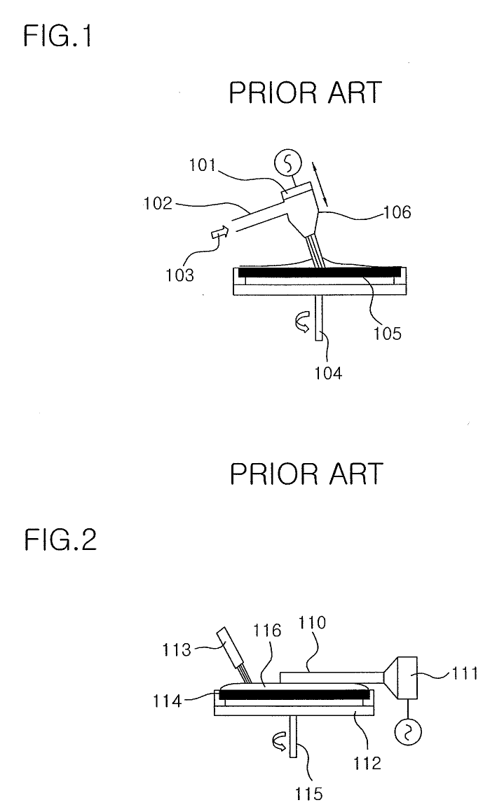

### DETAILED DESCRIPTION OF THE PREFERRED EMBODIMENTS

Now, preferred embodiments of the present invention will be described with reference to the accompanying drawings. In the following description, the terms or words used in the following description should not be analyzed by typical or dictionary means. The definitions of these terms should be analyzed by means and concepts corresponding to technical ideas of the present invention based on the principle that an inventor can appropriately define the concept of terms for explaining the invention in the most preferable manner.

Accordingly, since the embodiments disclosed herein and configurations illustrated in the drawings are only the most preferable embodiment and are not intended to represent all technical items of the invention, it should be appreciated that other various equivalents and modifications capable of substituting for the disclosed embodiments exist at the filing time point of the invention.

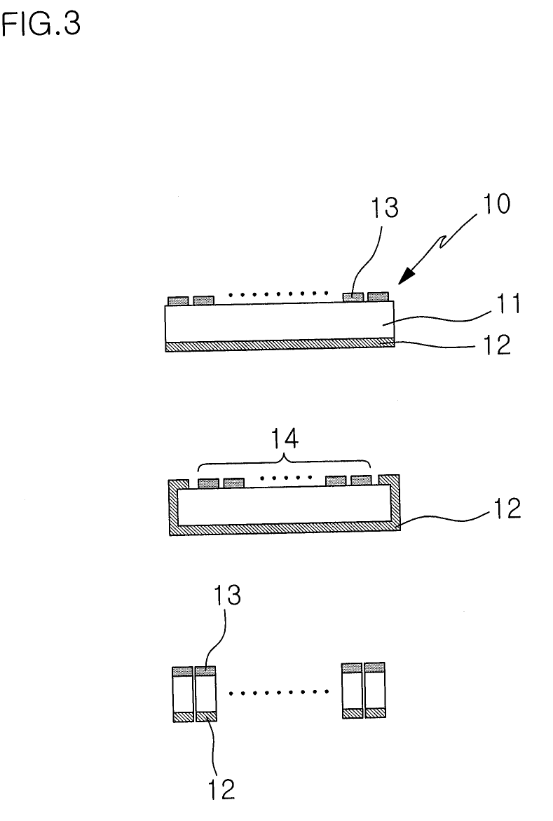

Hereinafter, a cleaning apparatus using ultrasonic waves according to preferred embodiments of the present invention will be described in detail with reference to FIGS. 3 to 15.

As shown, to efficiently separate contaminations from a wafer 70 to be cleaned, the cleaning apparatus comprises an oscillator 30, which is prepared by bonding a piezoelectric device 10 to a surface of a diffusive layer 22 consisting of a near-field region 20 and a far-field region 21. The cleaning apparatus uses ultrasonic waves generated from the oscillator 30, and further comprises a rod having a diameter-reduced portion to amplify the ultrasonic waves. In summary, the cleaning apparatus using ultrasonic waves comprises a tube 41, the rod 42 or 42′, a housings 40 or 43, and the oscillator 30.

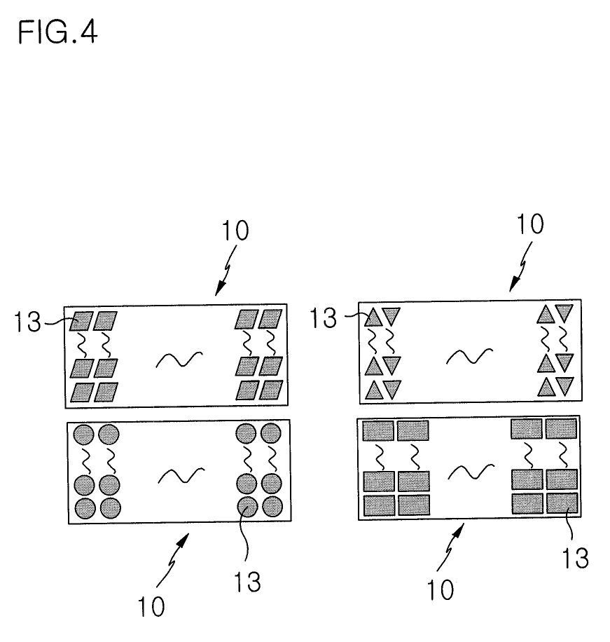

FIG. 3 is a sectional view illustrating the pole structure of the piezoelectric device according to the present invention, and FIG. 4 is a plan view of FIG. 3. As shown in FIGS. 3 and 4, the piezoelectric device 10 includes a piezoelectric ceramic plate 11 of various shapes, a positive pole 14 formed at one surface of the plate 11, and a negative pole 12 formed at the other surface of the plate 11. The positive pole 14 consists of a plurality of positive pole pieces 13 deposited on the plate 11 to be vertically and horizontally spaced apart from each other by a predetermined interval.

The piezoelectric device 10 may be configured in various manners. In one example, the positive pole 14, which consists of the plurality of positive pole pieces 13, is arranged on one surface of the plate 11 and the negative pole 12 is formed throughout the other surface of the plate 11. In another example, the positive pole 14, which consists of the plurality of positive pole pieces 13, is formed on an upper surface of the plate 11, and the negative pole 12 extends throughout a lower surface and a sidewall of the plate 11. In yet another example, the piezoelectric device 10 may include a plurality of piezoelectric ceramic units each including a single positive pole piece and a negative pole arranged at opposite surfaces of the plate 11.

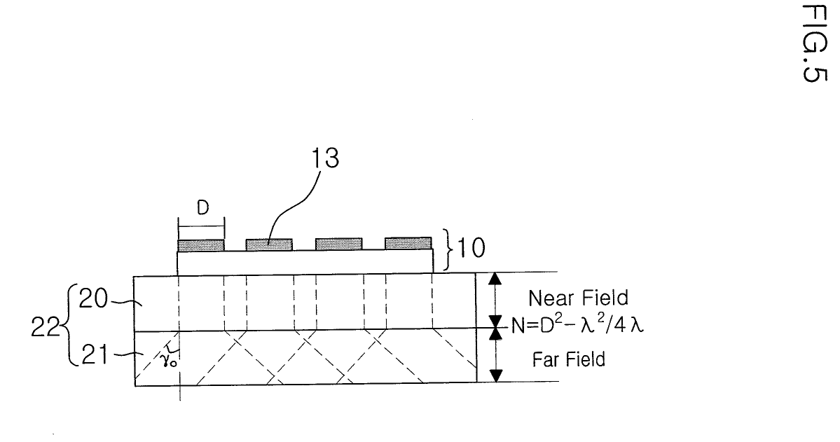

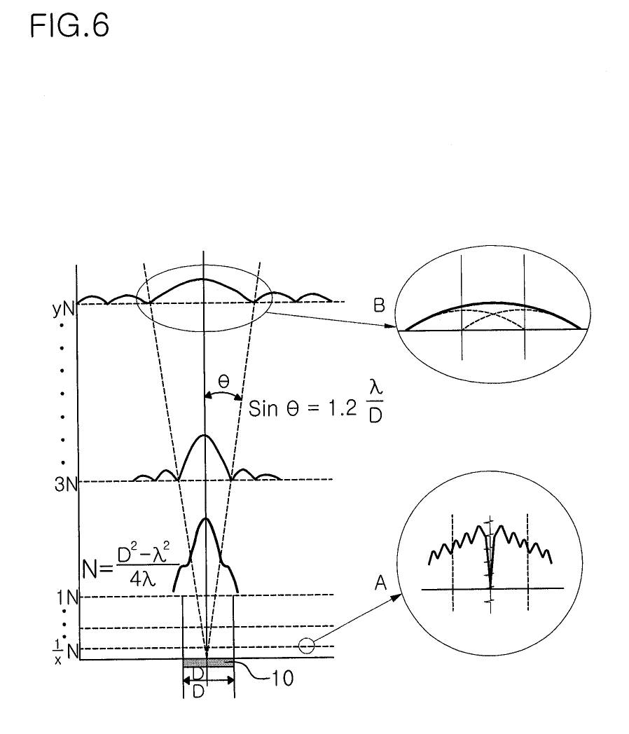

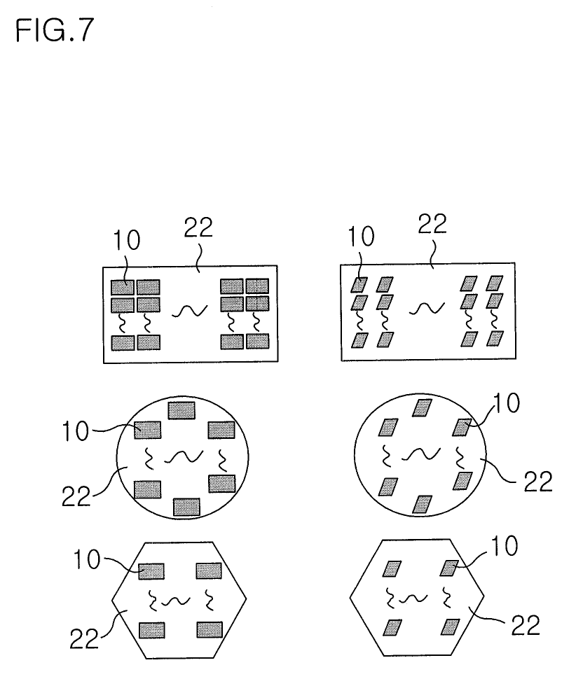

FIG. 5 is a sectional view illustrating the configuration and basic operation principle of the oscillator according to the present invention. FIG. 6 is an explanatory view illustrating the basic operation principle of the oscillator according to the present invention. FIG. 7 is a plan view of FIG. 5. As shown in FIGS. 5 to 7, the diffusive layer 22 is bonded to a surface of the piezoelectric device 10 such that a surface of the diffusive layer 22 is bonded to the negative pole 12 of the piezoelectric device 10. The diffusive layer 22 includes the near-field region 20 and the far-field region 21, and is bonded to the negative pole 12 of the piezoelectric device 10.

In FIG. 5, a distance from the surface of the diffusive layer 22, to which the piezoelectric device 10 is bonded, to the boundary where the near field region 20 ends and the far-field region 21 begins is represented by N=D²−λ²/4λ. Here, D is a width of each positive pole piece 13. Also, the diffusion angle of sound from the boundary of the near-field region 21 and the near-field region 21 into the far-field region 21 is represented by sin γ₀=1.2λ/D. That is, the smaller the width of the positive pole piece 13, the greater the diffusion angle sin γ₀. Accordingly, the adjustment of a far-field by the overlap of ultrasonic waves to be diffused over an object to be cleaned is possible. The diffusive layer 22 may be bonded, at a surface thereof, with a plurality of piezoelectric devices 10.

The diffusive layer 22 may be made of quartz, stainless-steel, Teflon, aluminum, steel, or the like.

The positive pole pieces 13 and the piezoelectric device 10 may have any one shape selected from among a square, a circle, a triangle, a rectangle, a parallelogram, etc. Also, the diffusive layer 22 may have any one shape selected by a user from among a square, a circle, a polygon, etc.

An oscillator, to which a near field is applied, is applicable to the portion A of FIG. 6 using a relatively uniform sound field, and an oscillator, to which a far-field is applied, is applicable to the portion B of FIG. 6 forming a relatively uniform sound filed by the overlap of ultrasonic waves emitted from a piezoelectric device.

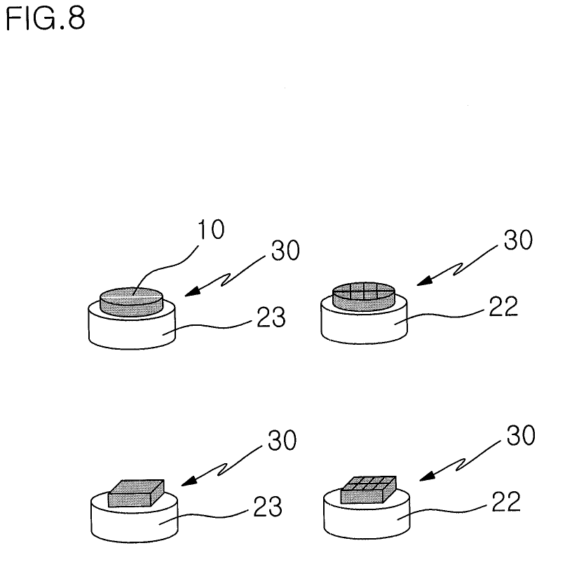

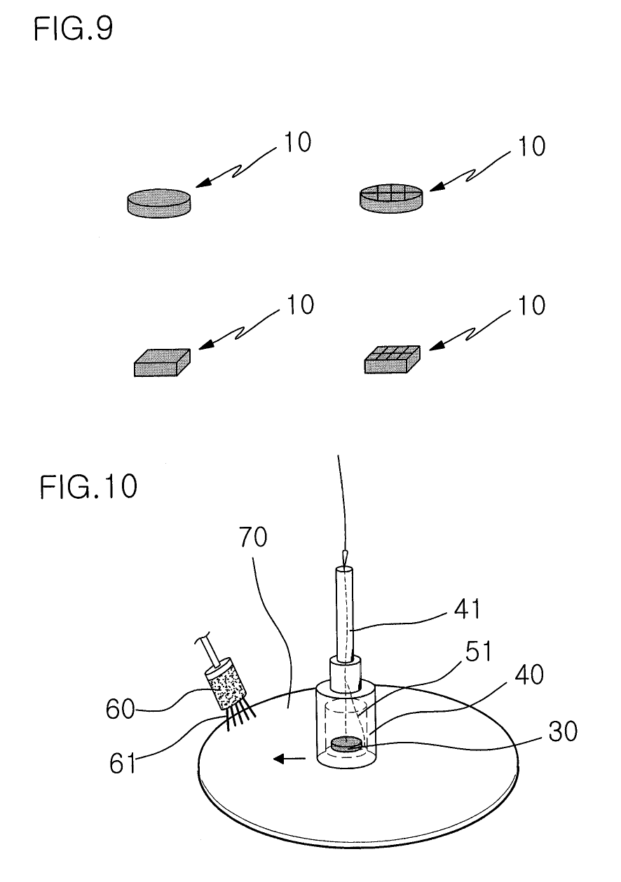

FIG. 8 is a perspective view illustrating an embodiment of the oscillator 30 according to the present invention. FIG. 9 is a perspective view illustrating an embodiment of the piezoelectric device 10 according to the present invention. As shown in FIGS. 8 and 9, the diffusive layer 22 includes the near-field region 20, in which ultrasonic waves propagate straight, and the far-field region 21 in which ultrasonic waves are diffused and overlapped. The piezoelectric device 10 is bonded to a surface of the diffusive layer 22, to produce ultrasonic waves by contraction and expansion thereof.

As shown in FIG. 8, the oscillator 30 may be configured in various manners. For example, the oscillator 30 may include the diffusive layer 22, which consists of the far-field region 21 and the near-field region 20, and the piezoelectric device 10, or may include an ultrasonic wave transmitter 23 and the piezoelectric device 10.

It will be appreciated that all the piezoelectric device 10 bonded to a surface of the ultrasonic wave transmitter 23, the ultrasonic wave transmitter 23, and the diffusive layer 22 may have any one cross section selected by a user from among a square, a circle, etc.

The piezoelectric device 10 may be comprised of a plurality of piezoelectric devices 10 vertically and horizontally spaced apart from one another by a predetermined interval. Also, the piezoelectric device 10, as described above, may have any one shape selected by a user from among a circle, a square, etc.

FIG. 9 illustrates the detailed configuration of the piezoelectric device 10 to be bonded to the ultrasonic wave transmitter 23 or the diffusive layer 22.

FIG. 10 is a perspective view illustrating a cleaning apparatus according to a first embodiment of the present invention. As shown in FIG. 10, the cleaning apparatus comprises a cylindrical hollow housing 40 receiving therein the oscillator 30 disposed on an end surface thereof. More specifically, the oscillator 30 is positioned as close as possible to a wafer 70 to be cleaned.

A tube 41 is coupled to a position of the housing 40 opposite to the end surface of the housing 40 maintaining a gap with the wafer 70.

As described above, the oscillator 30, disposed on the end surface of the housing 40, may include the ultrasonic wave transmitter 23 and the piezoelectric device 10 deposited on a surface of the ultrasonic wave transmitter 23, or may include the diffusive layer 22 consisting of the near-field region 20 and the far-field region 21 and the piezoelectric device 10 bonded to a surface of the diffusive layer 22.

As the oscillator 30 receives electricity from a power source through an electric wire 51, the piezoelectric device 10 is contracted and expanded upon receiving the electricity to thereby produce ultrasonic waves.

More specifically, the oscillator 30 to produce ultrasonic waves is oriented perpendicular to an upper surface of the wafer 70 to move over the upper surface of the wafer 70 while maintaining a predetermined gap with the wafer 70. The ultrasonic waves produced by the oscillator 30 are transmitted to cleaning water 61 applied onto the upper surface of the wafer 70 to be cleaned, so as to separate contaminations from the wafer 70.

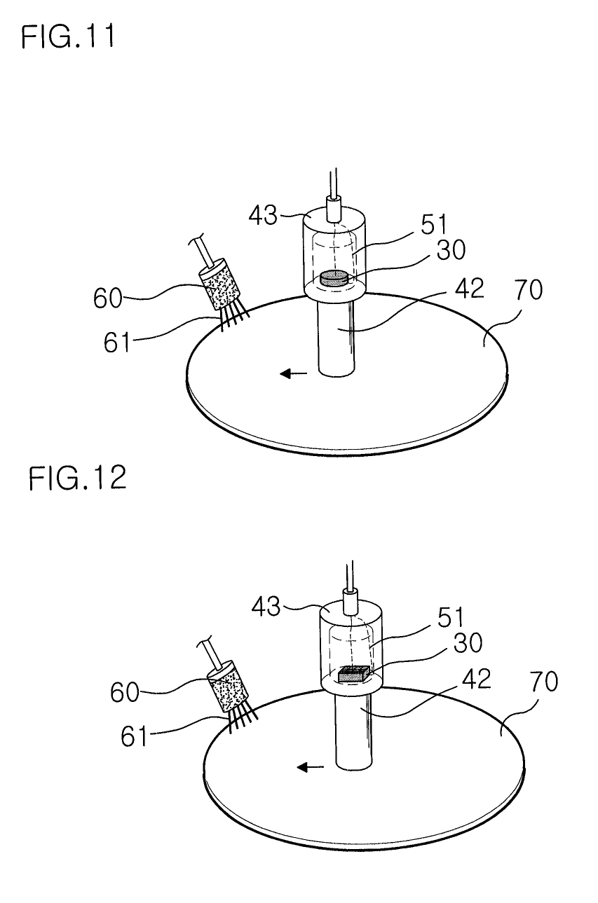

FIG. 11 is a perspective view illustrating a cleaning apparatus according to a second embodiment of the present invention. FIG. 12 is a perspective view illustrating an alternative embodiment of FIG. 11. As shown in FIGS. 11 and 12, to transmit ultrasonic waves to the cleaning water 61 applied onto the upper surface of the wafer 70 to be cleaned, differently from FIG. 10, a cylindrical rod 42 may be coupled to a surface of the oscillator 30.

The rod 42 may have a smaller or larger diameter than that of the oscillator 30, or may have the same diameter as that of the oscillator 30.

With the present embodiment, ultrasonic waves produced by the oscillator 30 are propagated in a longitudinal direction of the rod 42, which is oriented perpendicular to the wafer 70 while maintaining a predetermined gap with the wafer 70, thereby being transmitted to the cleaning water 61 applied onto the upper surface of the wafer 70.

When using the oscillator 30 related to the far-field region 21, furthermore, the diffusion and overlap effects of the ultrasonic waves can be enhanced.

In the above described embodiments, the housing 40 or 43 has a hollow tubular shape having any one cross section selected from among a square, a circle, a polygon, etc.

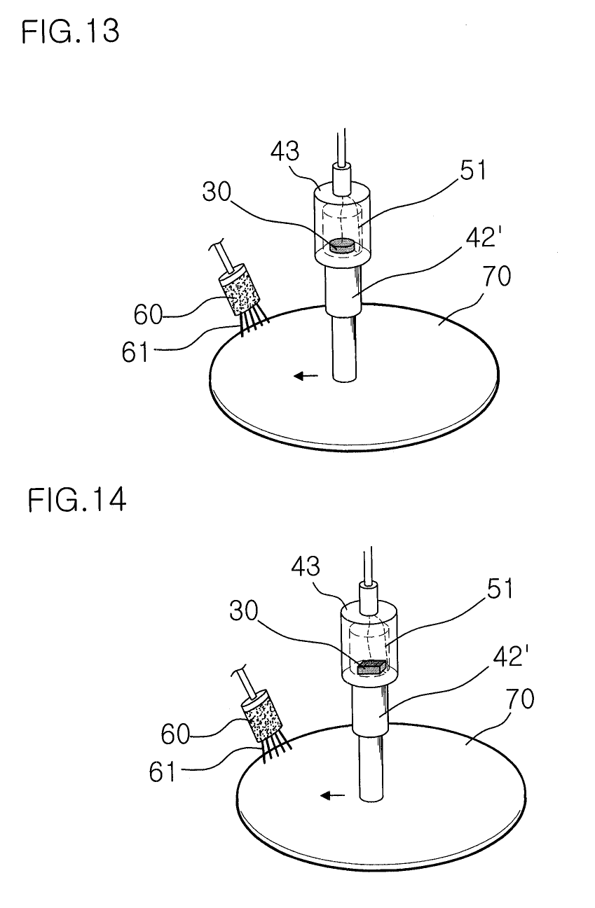

FIG. 13 is a perspective view illustrating a cleaning apparatus according to a third embodiment of the present invention. FIG. 14 is a perspective view illustrating an alternative embodiment of FIG. 13. In the present embodiment, the rod 42 as shown in FIGS. 11 and 12 is replaced by a rod 42′ having a diameter-reduced portion. The use of the rod 42′ having a diameter-reduced portion has the effect of allowing the ultrasonic waves, which will be transmitted to the cleaning water 61 applied onto the upper surface of the wafer 70, to be aggregated and amplified as they approach the wafer 70.

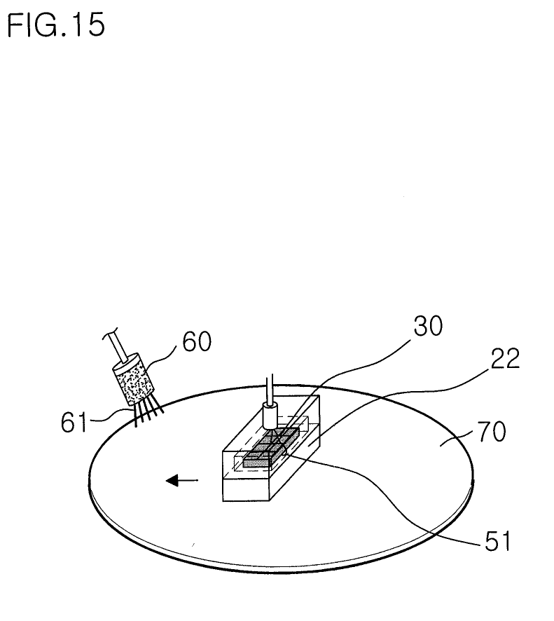

FIG. 15 is a perspective view illustrating a cleaning apparatus according to a fourth embodiment of the present invention. As shown in FIG. 15, the piezoelectric device 10 is bonded to the diffusive layer 22 having a rectangular cross section.

The cleaning apparatus of the present embodiment can separate contaminations on the wafer 70 while moving on the surface of the wafer 70, to which the cleaning water 61 was previously applied.

In the above description of the preferred embodiments of the present invention, the diffusive layer 22, the ultrasonic wave transmitter 23, and the rods 42 and 42′ may be made of any one material selected by a user from among glassy solids including quartz, sapphire, diamond and glassy carbon, metals including stainless steel, titanium, aluminum and steel, and other glassy materials or metals coated with a chemical resistance material such as Teflon, etc.

In the drawings, reference numeral 60 denotes a cleaning water discharger.

As apparent from the above description, the present invention provides a cleaning apparatus using ultrasonic waves, which comprises: a housing receiving therein an oscillator, which produces ultrasonic waves as a piezoelectric device is contracted and expanded upon receiving power during a cleaning of contaminations on a wafer; and a rod coupled to a surface of the oscillator to transmit the ultrasonic waves to cleaning water applied onto an upper surface of the wafer. The piezoelectric device is bonded to a surface of a diffusive layer consisting of a near-field region in which the ultrasonic waves propagate straight and a far-field region in which the ultrasonic waves are diffused and overlapped, to complete the oscillator. Also, the rod has a diameter-reduced portion to amplify the ultrasonic waves produced from the oscillator for the efficient removal of the contaminations on the wafer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cleaning apparatus using ultrasonic waves comprising:
a tube;
a housing coupled to an end of the tube and disposed perpendicular to a wafer to be cleaned while maintaining a gap with the wafer; and
an oscillator provided in the housing at a position to face the wafer and used to produce ultrasonic waves.

2. A cleaning apparatus using ultrasonic waves comprising:
a hollow housing:
an oscillator coupled to the housing at a position to face a wafer to be cleaned and used to produce ultrasonic waves; and
a constant-diameter rod having an end coupled to a surface of the oscillator, the rod being disposed perpendicular to an upper surface of the wafer to transmit the ultrasonic waves, produced from the oscillator, to cleaning water applied onto the upper surface of the wafer.

3. The cleaning apparatus according to claim 2, wherein the constant-diameter rod is replaced by a rod having a diameter-reduced portion defined in the longitudinal opposite side of an oscillator coupling end thereof, to amplify the ultrasonic waves produced from the oscillator and transmit the amplified ultrasonic waves to the cleaning water applied onto the upper surface of the wafer to be cleaned.

4. The cleaning apparatus according to claim 1, wherein the oscillator produces ultrasonic waves as a piezoelectric device is contracted and expanded upon receiving power through an electric wire.

5-14. (canceled)

15. The cleaning apparatus according to claim 2, wherein the oscillator produces ultrasonic waves as a piezoelectric device is contracted and expanded upon receiving power through an electric wire.

16. The cleaning apparatus according to claim 1, wherein the oscillator comprises a piezoelectric device bonded to a surface of any one of an ultrasonic wave transmitter and a diffusive layer.

17. The cleaning apparatus according to claim 2, wherein the oscillator comprises a piezoelectric device bonded to a surface of any one of an ultrasonic wave transmitter and a diffusive layer.

18. The cleaning apparatus according to claim 16, wherein the diffusive layer, the ultrasonic wave transmitter, and the rod are made of any one material selected from among glassy solids including quartz, sapphire, diamond, and glassy carbon.

19. The cleaning apparatus according to claim 17, wherein the diffusive layer, the ultrasonic wave transmitter, and the rod are made of any one material selected from among glassy solids including quartz, sapphire, diamond, and glassy carbon.

20. The cleaning apparatus according to claim 16, wherein the diffusive layer, the ultrasonic wave transmitter, and the rod are made of any one material selected from among metals including stainless steel, titanium, aluminum, and steel and other metals coated with a chemical resistance material such as Teflon.

21. The cleaning apparatus according to claim 17, wherein the diffusive layer, the ultrasonic wave transmitter, and the rod are made of any one material selected from among metals including stainless steel, titanium, aluminum, and steel and other metals coated with a chemical resistance material such as Teflon.

22. The cleaning apparatus according to claim 16, wherein the diffusive layer and the ultrasonic wave transmitter have a square, circular, or polygonal cross section.

23. The cleaning apparatus according to claim 17, wherein the diffusive layer and the ultrasonic wave transmitter have a square, circular, or polygonal cross section.

24. The cleaning apparatus according to claim 2, wherein the oscillator and the rod are integrally formed with each other.

25. The cleaning apparatus according to claim 3, wherein the oscillator and the rod are integrally formed with each other.

26. The cleaning apparatus according to claim 2, wherein the oscillator and the rod are coupled with each other such that their facing regions come into contact with each other.

27. The cleaning apparatus according to claim 3, wherein the oscillator and the rod are coupled with each other such that their facing regions come into contact with each other.

28. The cleaning apparatus according to claim 1, wherein the oscillator has a square, circular, or polygonal cross section.

29. The cleaning apparatus according to claim 2, wherein the oscillator has a square, circular, or polygonal cross section.

30. The cleaning apparatus according to claim 4, wherein the piezoelectric device has a circular, square, diamond, triangular, or parallelogram shape, and is bonded to a surface of any one of an ultrasonic wave transmitter and a diffusive layer.

31. The cleaning apparatus according to claim 15, wherein the piezoelectric device has a circular, square, diamond, triangular, or parallelogram shape, and is bonded to a surface of any one of an ultrasonic wave transmitter and a diffusive layer.

32. The cleaning apparatus according to claim 1,
wherein the oscillator comprises a piezoelectric device bonded to a surface of a diffusive layer in which ultrasonic waves are diffused and overlapped, and
wherein the piezoelectric device comprises a piezoelectric ceramic plate, a plurality of positive pole pieces deposited on one surface of the piezoelectric ceramic plate to be vertically and horizontally spaced apart from one another by a predetermined interval, and a negative pole deposited on the other surface of the piezoelectric ceramic plate, the piezoelectric device reducing a deviation in a sound pressure of the ultrasonic waves.

33. The cleaning apparatus according to claim 2,
wherein the oscillator comprises a piezoelectric device bonded to a surface of a diffusive layer in which ultrasonic waves are diffused and overlapped, and
wherein the piezoelectric device comprises a piezoelectric ceramic plate, a plurality of positive pole pieces deposited on one surface of the piezoelectric ceramic plate to be vertically and horizontally spaced apart from one another by a predetermined interval, and a negative pole deposited on the other surface of the piezoelectric ceramic plate, the piezoelectric device reducing a deviation in a sound pressure of the ultrasonic waves.

34. The cleaning apparatus according to claim 32, wherein an ultrasonic wave creating diffusion angle increases as a width of the positive pole pieces decreases.

35. The cleaning apparatus according to claim 33, wherein an ultrasonic wave creating diffusion angle increases as a width of the positive pole pieces decreases.
